(19) United States
(12) Patent Application Publication
(10) Pub. No.: US 2010/0108855 A1
(43) Pub. Date: May 6, 2010

(54) ELECTRONIC APPARATUS AND ROTATING MODULE THEREOF

(75) Inventors: Chi Hung Hsiao, Taipei (TW); Peng Chung Chou, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: QISDA CORPORATION, Taoyuan (TW)

(21) Appl. No.: 12/612,317

(22) Filed: Nov. 4, 2009

(30) Foreign Application Priority Data
Nov. 5, 2008 (TW) 097142771

(51) Int. Cl. F16M 11/00

(52) U.S. Cl. 248/672

(57) ABSTRACT

The present invention provides an electronic apparatus and a rotating module thereof. The electronic apparatus includes a base and the rotating module. The rotating module includes a rotator and a bracket. The bracket is connected to the rotator and mounts the rotator on the base. The bracket includes a main structure and a locking part which is on a reference surface. In particular, the distance between the axle of the rotator and the reference surface is smaller than two thirds of the radius of the rotator. Moreover, the locking part is located at a bended portion which is extended from the main structure and had been bended at least two times.

### BACKGROUND OF THE INVENTION

1. Field of the Invention

The invention relates to a rotating module and an electronic apparatus, and particularly, the invention relates to a rotating module and an electronic apparatus capable of decreasing the vibration and the noise generated by the rotator.

2. Description of the Prior Art

Projectors are the complex integration of optics, mechanics, and electronics. During operation, huge thermal energy will be generated, which will damage the components inside the projector. Since components inside the projector are sensitive to the heat, the heat dissipation of projectors is an important issue for the manufacturer. Especially, it is a great task to dissipate heat efficiently with less noise in miniaturized projectors.

The conventional method, “forced convection”, is used to dissipate heat by using a fan to bring the air with high thermal energy off from the heat-producing component out of the projector. Please refer to FIG. 1A and FIG. 1B. FIG. 1A is an assembly drawing illustrating the heat dissipating module 10 applied in the projector in the prior art. FIG. 1B is a front view of the heat dissipating module 10 in FIG. 1A. As shown in FIG. 1A, the heat dissipating module 10 includes a fan 100 and a bracket 102. The fan 100 is coupled to the bracket 102 by positioning pillars 11 and 12. The bracket 102 is locked at the base of the projector by a locking part 1020. The fan 100 is set close to and aligned to the main heat-producing component of the projector. Thus, the projector could be cooled under the appropriated temperature even for long time operation.

The fan 100, the bracket 102, and the base of the projector are independent objects, and it is inevitable that the intervals exist after assembling. While the fan 100 rotates, the heat dissipating module 10 vibrates as a whole and results in noise. The vibration caused by the operation of the fan 100 transmits to the projector through the bracket 102, which generates the vibration of the projector and the louder noise.

The reason why the noise and the vibration exists in the heating dissipating module 10 in FIG. 1B is that the distance, between the locking part 1020 of the bracket 102 and the rotating center of the fan 100 (the vibrating center of the fan 100), is further for the simple structure and the low cost. Besides, the locking part 1020 of the bracket 102 for fixing the bracket 102 at the base of the projector in FIG. 1A is only bended once. For solving the aforementioned problem, a vibration restraining component 104 such as a sponge is disposed between the bracket 102 and the projector generally, as shown in FIG. 1A and FIG. 1B. However, it does not decrease the vibration and the noise well.

Therefore, a main scope of the invention is to provide an electronic device and a rotating module thereof. By shortening the distance between the locking part of the bracket and the rotating center of the rotator in the rotating module and forming the bended portion of the bracket with two bends at least, the vibration and the noise problem generated by the rotator could be solved effectively. Besides, the vibration restraining component could be removed from the bracket and the projector to lower the cost.

### SUMMARY OF THE INVENTION

A scope of the invention is to provide a rotating module configured on a standard surface and including a rotator and a bracket. The rotator has a radius and it rotates around an axle. The bracket is coupled to the rotator and fixes the rotator on the standard surface. The bracket includes a main structure and a locking part. The main structure partially covers the rotator and exposes a part of the rotator. The locking part is extended form the main structure and located on a reference. In particular, the distance between the axle of the rotator and the reference surface is smaller than two thirds of the radius of the rotator.

Another scope of the invention is to provide a rotating module configured on a standard surface and including a rotator and a bracket. The bracket is coupled to the rotator and fixes the rotator on the standard surface. The bracket includes a main structure and a bended portion. The main structure partially covers the rotator and exposes a part of the rotator. The bended portion is extended from the main structure and had been bended at least two times to form a locking part.

Another scope of the invention is to provide an electronic apparatus including a base and a rotating module. The rotating module is configured on the base and includes a rotator and a bracket. The rotator has a radius and it rotates around an axle. The bracket is coupled to the rotator and fixes the rotator on the base. The bracket includes a main structure and a locking part. The main structure partially covers the rotator and exposes a part of the rotator. The locking part is extended form the main structure and located on a reference surface. In particular, the distance between the axle of the rotator and the reference surface is smaller than two thirds of the radius of the rotator.

Another scope of the invention is to provide an electronic apparatus including a base and a rotating module. The rotating module is configured on the base and includes a rotator and a bracket. The bracket is coupled to the rotator and fixes the rotator on the base. The bracket includes a main structure and a bended portion. The main structure partially covers the rotator and exposes a part of the rotator. The bended portion is extended from the main structure and had been bended at least two times to form a locking part.

Therefore, according to the rotating module and the electronic apparatus of the embodiments of the invention, by shortening the distance between the locking part of the bracket and the rotating center of the rotator in the rotating module and forming the bended portion of the bracket with two bends at least, the vibration and the noise problem generated by the rotator could be solved effectively.

The advantage and spirit of the invention may be understood by the following recitations together with the appended drawings.

### BRIEF DESCRIPTION OF THE APPENDED DRAWINGS

FIG. 1A is an assembly drawing illustrating the heat dissipating module applied in the projector in the prior art.

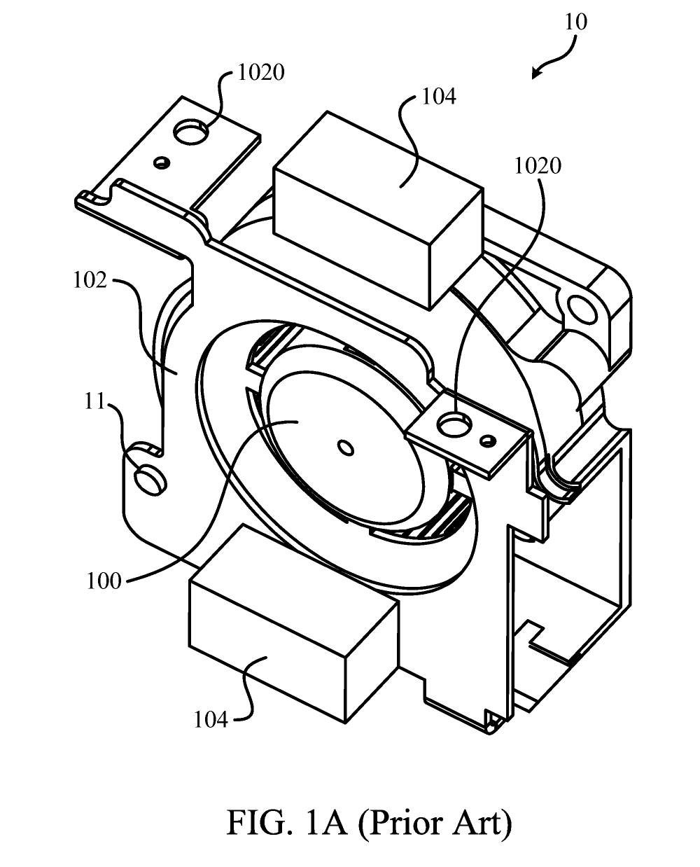

FIG. 1B is a front view of the heat dissipating module in FIG. 1A.

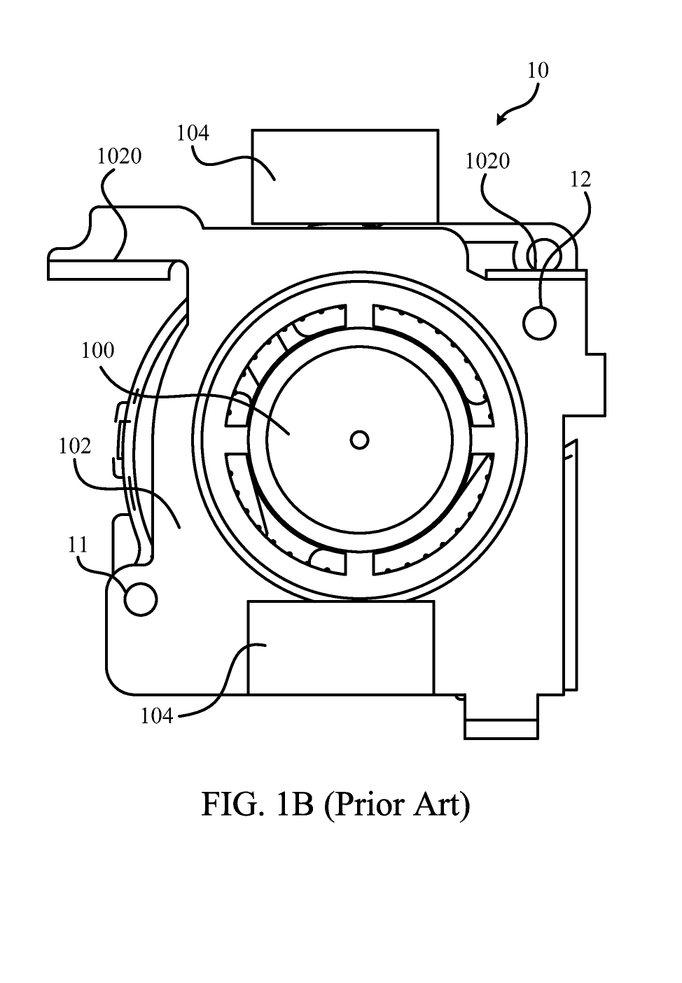

FIG. 2A is an assembly drawing illustrating the rotating module fixed at the electronic apparatus according to an embodiment of the invention.

FIG. 2B is an exploded drawing of the rotating module in the electronic apparatus in FIG. 2A.

FIG. 3 is a front view of the rotating module in FIG. 2A.

### DETAILED DESCRIPTION OF THE INVENTION

The invention is to provide a rotating module and an electronic apparatus. Particularly, the distance between the locking part of the bracket and the rotating center of the rotator in the rotating module is shortened than that in the prior art and the bended portion of the bracket had been bended twice, which solves the vibration and the noise problem generated by the rotator effectively.

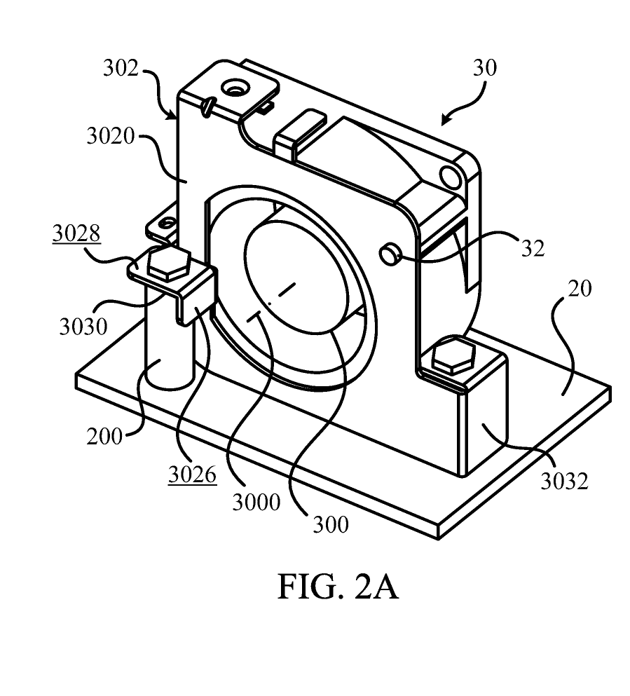

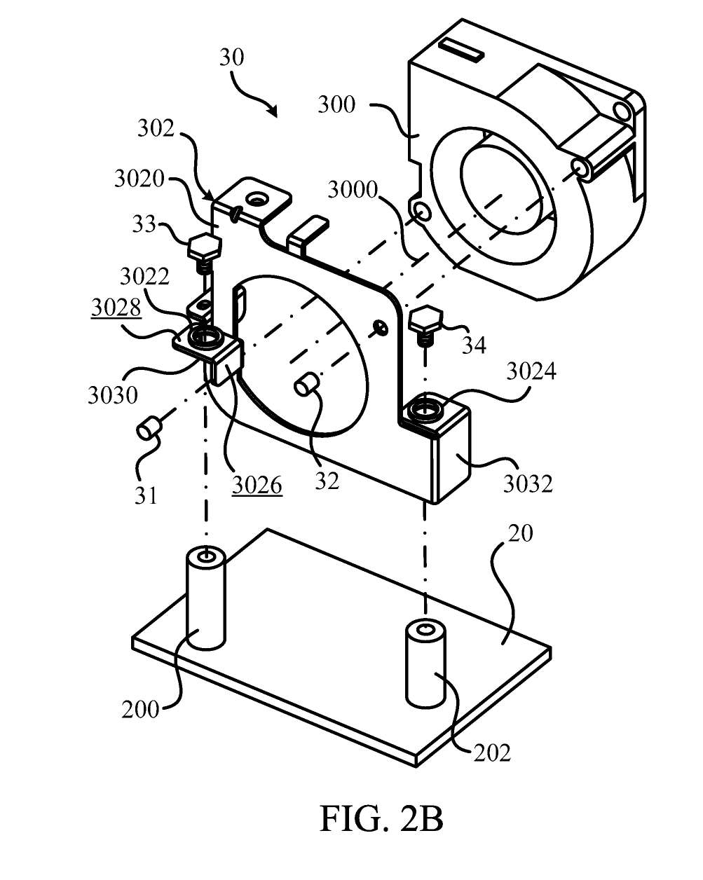

Please refer to FIG. 2A and FIG. 2B. FIG. 2A shows the rotating module 30 fixed at the electronic apparatus (not shown in the figure) according to an embodiment of the invention. FIG. 2B is an exploded drawing of the rotating module 30 in the electronic apparatus in FIG. 2A. As shown in FIG. 2A and FIG. 2B, the electronic apparatus of the invention includes a base 20 and the rotating module 30. The rotating module 30 configured on the base 20 of the electronic apparatus includes a rotator 300 and a bracket 302. The rotating module may be but not limit to a heat dissipating module, the rotator may be but not limit to as a fan, the electronic apparatus may be a projector, a computer, and the kind which includes the rotator. The details of the construction, the function, and the operation of the embodiment of the invention would be described as the following.

As shown in FIG. 2A, the rotator 300 (such as a fan) could rotate around an axle 3000 to generate an airflow in the electronic apparatus. Besides, the rotator 300 has a radius with a specific length. In this embodiment, the electronic apparatus is a projector including a light engine system (not shown in the figure) and a nozzle (not shown in the figure). The nozzle is disposed between the rotator 300 and the light engine system to guide the airflow into the light engine system.

As shown in FIG. 2B, the rotator 300 is coupled to the bracket 302 of the rotating module 30 by the position pillars 31 and 32 and fixed on the base 20 of the electronic apparatus. The bracket 302 includes a main structure 3020, a first locking part 3022 and a second locking part 3024. The rotator 300 leans on the main structure 3020 of the bracket 302. The main structure 3020 partially covers the rotator 300 and makes a part of the rotator 300 exposed. The first locking part 3022 and the second locking part 3024 are extended form the main structure 3020.

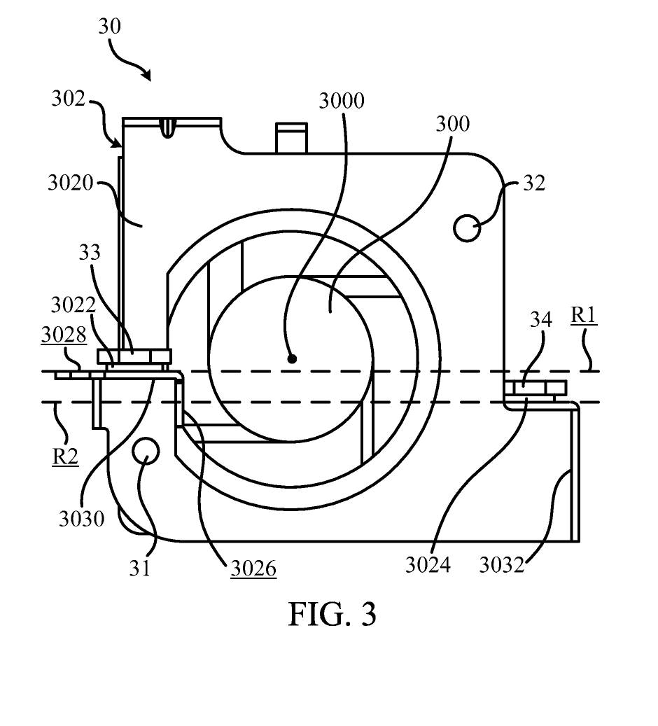

Please refer to FIG. 3. FIG. 3 is a front view illustrating the rotating module 30 in FIG. 2A. As shown in FIG. 3, the first locking part 3022 is located on a first reference surface R1, and the second locking part 3024 is located on the second reference surface R2. Based on the consideration for product design and the assembling tolerance, the distances from the axle 3000 of the rotator 300 to the first reference surface R1 and the second reference surface R2 are smaller than two thirds of the radius of the rotator 300.

In other words, a feature of the invention is to make the first reference surface R1 (where the first locking part 3022 located) and the second reference surface R2 (where the second locking part 3024 located) as close as possible to the axle 3000 of the rotator 300 (namely, the rotating center) to effectively decrease the vibration generated by the rotator 300. It is the reason that the closer to the rotating center, the less vibrating torque is generated, which keeps not only the rotating module 30 but also the electronic apparatus stable.

Therefore, in the preferred embodiment, the axle 3000 of the rotator 300 of the rotating module 30, the first reference surface R1, and the second reference surface R2 are substantially at the same height relative to the base of the electronic apparatus, and the vibration generated by the rotator 300 is greatly decreased to obtain the optimum vibration restraining effect on both the rotating module and the whole electronic apparatus.

As shown in FIG. 2B, the bracket 302 of the rotating module 30 includes a first bended portion 3030 and a second bended portion 3032. The first bended portion 3030 and the second bended portion 3032 are extended from the bracket, and the first locking part 3022 and the second locking part 3024 are respectively configured at the first bended portion 3030 and the second bended portion 3032. Compared to the prior art, the first bended portion 3030 and the second bended portion 3032 of the bracket 302 of the rotating module 30 in the invention had been bended twice at least.

In other words, another feature of the invention is that the first bended portion 3030 and the second bended portion 3032 of the bracket 302 of the rotating module 30 had been bended twice at least. The vibration transmitted from the rotator 300 to the base 20 would be weakened through several bends, so as to greatly decrease the vibration transmitted from the rotator 300 to the whole electronic apparatus.

In the preferred embodiment, the first bended portion 3030 of the bracket 302 of the rotating module 30 includes a first surface 3026 and a second surface 3028.

The first surface 3026 is extended from the main structure 3020 of the bracket 302. The second surface 3028 is connected to and extended from the first surface 3026. The bends, between the main structure 3020 and the first surface 3026 and between the first surface 3026 and the second surface 3028, weaken the vibration generated by the rotator 300 transmitted to the electronic apparatus. Besides, the first surface 3026 of the first bended portion 3030 is preferably perpendicular to the main structure 3020 (namely, the angle between the first surface 3026 and the main structure 3020 is)90°, and the second surface 3028 is preferably perpendicular to the first surface 3026. The second locking part 3024 of the second bended 3032 has the same configuration and the related description is omitted. It should be noted that the number of the surfaces of the bended portion and the angle between the surfaces may be modified according to the practical application and not be limited to the embodiments of the invention.

Besides, as shown in FIG. 2B, the base 20 has a first protruding portion 200 corresponding to the first locking part 3022 and a second protruding portion 202 corresponding to the second locking part 3024. The first protruding portion 200 and the second protruding portion 202 are extended from the base 20 of the electronic apparatus, and are connected to the first locking part 3022 and the second locking part 3024 by screws 33 and 34 respectively.

According to the rotating module and the electronic apparatus in the embodiments of the invention, the vibration and the noise problem generated by the rotator could be solved effectively by forming the bended portion of the bracket with two bends at least and setting the locking part of the bracket as close as possible to the rotating center in the rotating module. Besides, the vibration restraining component could be removed from the bracket and the projector to lower the cost.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A rotating module, configured on a standard surface, comprising:
a rotator, rotating around an axle, the rotator having a radius; and
a bracket, coupled to the rotator and fixing the rotator on the standard surface, the bracket comprising:
a main structure, partially covering the rotator and exposing a part of the rotator; and
a locking part, extended from the main structure and located on a reference surface;
wherein, a distance between the axle of the rotator and the reference surface is smaller than two thirds of the radius of the rotator.

2. The rotating module of claim 1, wherein the axle of the rotator and the reference surface are substantially as high as the standard surface.

3. The rotating module of claim 1, wherein the bracket further comprises a bended portion which is extended from the main structure and had been bended at least two times, and the locking part is located at the bended portion.

4. The rotating module of claim 3, wherein the bended portion comprises:
a first surface, extended from the main structure; and
a second surface, connected to the first surface, the locking part being located on the second surface.

5. The rotating module of claim 4, wherein the first surface is perpendicular to the main structure and the second surface is perpendicular to the first surface.

6. A rotating module, configured on a standard surface, the rotating module comprising:
a rotator; and
a bracket, coupled to the rotator and fixing the rotator on the standard surface, the bracket comprising:
a main structure, partially covering the rotator and exposing a part of the rotator; and
a bended portion, extended from the main structure and bended at least two times to form a locking part.

7. The rotating module of claim 6, wherein the bended portion comprises:
a first surface, extended from the main structure; and
a second surface, connected to the first surface, the locking part being located on the second surface.

8. The rotating module of claim 7, wherein the first surface is perpendicular to the main structure and the second surface is perpendicular to the first surface.

9. The rotating module of claim 6, wherein the locking part is located on a reference surface, the rotator has a radius and rotates around an axle, and a distance between the axle of the rotator and the reference surface is smaller than two thirds of the radius of the rotator.

10. The rotating module of claim 9, wherein the axle of the rotator and the reference surface are substantially as high as the standard surface.

11. An electronic apparatus, comprising:
a base; and
a rotating module, configured on the base, the rotating module comprising:
a rotator, rotating around an axle, the rotator having a radius; and
a bracket, coupled to the rotator and fixing the rotator on the base, the bracket comprising:
a main structure, partially covering the rotator and exposing a part of the rotator; and
a locking part, extended from the main structure and located on a reference surface;
wherein, a distance between the axle of the rotator and the reference surface is smaller than two thirds of the radius of the rotator.

12. The electronic apparatus of claim 11, wherein the axle of the rotator and the reference surface are substantially as high as the base.

13. The electronic apparatus of claim 11, wherein the base has a protruding portion, and the locking part of the bracket is connected to the protruding portion.

14. The electronic apparatus of claim 11, wherein the bracket further comprises a bended portion which is extended from the main structure and had been bended at least two times.

15. The electronic apparatus of claim 14, wherein the bended portion comprises:
a first surface, extended from the main structure; and
a second surface, connected to the first surface, the locking part being located on the second surface.

16. The electronic apparatus of claim 15, wherein the first surface is perpendicular to the main structure and the second surface is perpendicular to the first surface.

17. An electronic apparatus, comprising:
a base; and
a rotating module, configured on the base, the rotating module comprising:
a rotator, rotating around an axle, the rotator having a radius; and
a bracket, coupled to the rotator and fixing the rotator on the base, the bracket comprising:
a main structure, partially covering the rotator and exposing a part of the rotator; and
a bended portion, extended from the main structure and bended at least two times to form a locking part connected to the base.

18. The electronic apparatus of claim 17, wherein the bended portion comprises:
a first surface, extended from the main structure; and
a second surface, connected to the first surface, the locking part being located on the second surface.

19. The electronic apparatus of claim 18, wherein first surface is perpendicular to the main structure and the second surface is perpendicular to the first surface.

20. The electronic apparatus of claim 17, wherein the base has a protruding portion, and the locking part of the bracket is connected to the protruding portion.

21. The electronic apparatus of claim 17, wherein the locking part is located on a reference surface, the rotator has a radius and rotates around an axle, and a distance between the axle of the rotator and the reference surface is smaller than two thirds of the radius of the rotator.

22. The electronic apparatus of claim 21, wherein the axle of the rotator and the reference surface are substantially as high as the base.
